(19) United States
(12) Patent Application Publication
(10) Pub. No.: US 2009/0096287 A1
(43) Pub. Date: Apr. 16, 2009

(54) POWER SOURCE FOR ELECTRIC APPLIANCES AND ELECTRIC APPLIANCES ADOPTING THE POWER SOURCE THEREOF

(76) Inventors: Weiliang Jiang, Yongkang (CN); Shiqing Wu, Yongkang (CN)

Correspondence Address: MCGARRY BAIR PC, 32 Market Ave. SW, SUITE 500, GRAND RAPIDS, MI, 49503, US

(21) Appl. No.: 12/028,795

(22) Filed: Feb. 9, 2008

(30) Foreign Application Priority Data
Oct. 15, 2007 (CN) 200710156260.8

(51) Int. Cl. H02J 5/00

(52) U.S. Cl. 307/31

(57) ABSTRACT

An electric appliance adopting novel power source includes a split type power source and at least two appliance main bodies. There are at least two output ports on the power source and the appliance body can be connected to the output ports in splicing. An alternative current servo controller is adopted in the power source and input end of the power source is powered by alternative current electric supply. Permanent magnet brushless direct current motors are adopted on the body of the appliance. The lifetime of appliance is increased and it is energy saving, safe and flexible. It avoids interference on other equipment during the course of operation. Precise high speed braking can be realized. Workers can work by holding the appliance body with rather small weight and small volume, which decreases labor strength of workers, relieves work fatigue and increases work efficiency.

### CROSS-REFERENCE TO RELATED APPLICATION

This application claims the benefit of Chinese Application Serial No. 200710156260.8, filed Oct. 15, 2007, which is incorporated herein by reference in its entirety.

### BACKGROUND OF THE INVENTION

1. Field of the Invention

The invention involves portable electric tools, movable electric tools, gardening tools, woodworking tools and their power sources, especially involves such fields as portable electric tools, movable electric tools, gardening tools and woodworking tools adopting conventional series machines or induction machines as the power sources.

2. Background of the Invention

In operation of such electric appliances as portable electric tools, movable electric tools, gardening tools and woodworking tools, a motor is adopted to convert electricity energy into mechanical energy so that to drive related tools to rotate or move and related work can be finished. At present, series machines are adopted for most of such type of products and induction machines are adopted for parts of gardening tools.

Present technology has many defects which can not be overcome:

Lifetime of commutators in general series machines is only several hundreds hours. Lifetime of commutators and carbon brushes directly restricts the lifetime of whole product; electromagnetism will be generated in operation of commutators and it will interferes with electricity network or other wireless devices; precise double close loop control can not be realized in series machines; because voltage is controlled through the angle of current flow of the silicon controlled rectifier in speed adjusting function, the torsional moment of the series machine in low speed is rather small; precise high speed braking can not be realized in series machines.

Electric appliances, especially portable electric appliances include both motors and controllers, so they have heavy weight and large volume, which increases strength of worker's operation, so work fatigue is easy to be caused and work efficiency will be affected.

Although the applicant wants to adopt the structure of alternative current servo controller in combination with permanent magnet brushless direct current motors, overall costs of the structure are rather high. If an alternative current servo control drives a permanent magnet brushless direct current motor, the costs for individual product should be RMB 400Yuan when costs of both are calculated as RMB 200Yuan. Therefore, product costs are increased greatly and the cost increase is more obvious for product with lower costs of body. So technicians in the field as well as I always think that the technology can not be realized in above stated electric appliances.

### SUMMARY OF THE INVENTION

Purpose of the invention is to solve problems in existing technologies. A power source for electric appliances and electric appliances adopting the power source thereof are disclosed. The electric appliances using the power source has long lifetime, high control precision, high speed response and it can realize high speed braking.

In order to realize above purposes, a kind of electric appliance adopting novel power source is disclosed in the invention, including a split type power source and at least two appliance main bodies. There are at least two output ports on the power source and the appliance body can be connected to the output ports in splicing. An alternative current servo controller is adopted in the power source and input end of the power source is powered by alternative current electric supply. Permanent magnet brushless direct current motors are adopted on the body of the appliance.

Preferably, the power source is provided with four output ports and one appliance body can be connected to every output port.

Preferably, the power source is provided with five output ports and one appliance body can be connected to every output port.

Preferably, the power source is provided with six output ports and one appliance body can be connected to every output port.

Preferably, the said alternative current servo controller includes a control panel and a power board. The control panel includes a digital signal processing chip and a programmable logic chip. High frequency pulse modulation control signals are generated by combining digital circuit and software control and they are outputted to various output ports after being amplified by the power board.

Preferably, the said permanent magnet brushless direct current motors include an electronic switch circuit, a rotor position detection circuit and a motor body. The said electronic switch circuit, the rotor position detection circuit and the motor body consist of a closed loop in sequence.

Preferably, the said motor body includes a coaxial external armature and a coaxial internal armature. The external armature is a fixed stator and the internal armature is a rotatable rotor which is a permanent magnet.

In order to realize above purposes, a kind of power source for electric appliances is also disclosed in the invention. There are at least two output ports on the power source and the appliance body can be connected to the output ports. An alternative current servo controller is adopted in the power source and input end of the power source is powered by alternative current electric supply.

Preferably, the power source is provided with four or five or six output ports and one appliance body can be connected to every output port.

Preferably, the said alternative current servo controller includes a control panel and a power board. The control panel includes a digital signal processing chip and a programmable logic chip. High frequency pulse modulation control signals are generated by combining digital circuit and software control and they are outputted to various output ports after being amplified by the power board.

Beneficial effects of the invention: (1) an alternative servo controller is used as the power source in the invention and permanent magnet brushless direct current motors are adopted on the appliance body. Electronic commutators are adopted to replace original mechanical commutators, which increases the lifetime of appliances. Precise double loop control is adopted and it is more energy saving, safer and more flexible than series machines. It has no interference on other equipments and precise high speed braking can be realized. (2) After the power source is separated from the appliance body, workers can work only by holding the appliance body with rather small weight and small volume, which decreases labor strength of workers, relieves work fatigue and increases work efficiency. Application of splicing can realize rather long distance of operation, which is convenient for operation. (3) Technical prejudices in the field are overcome and the alternative current servo controller is combined with permanent magnet brushless direct current motors. Technical scheme of adopting one alternative current servo controller to drive many permanent magnet brushless direct current motors is adopted in the invention, so that the problem of high costs is solved and it makes it possible to apply the alternative current servo controller into this type of products, which expands application scopes of the product greatly and promotes great development of electric tools, gardening tools and woodworking tools. It is a revolutionary innovation on this trade.

Features and advantages of the invention will be illustrated by combining examples and attachment diagram.

### BRIEF DESCRIPTION OF THE DRAWINGS

FIG. 1 is the structural schematic diagram of the invention.

### DETAILED DESCRIPTION

### Example 1

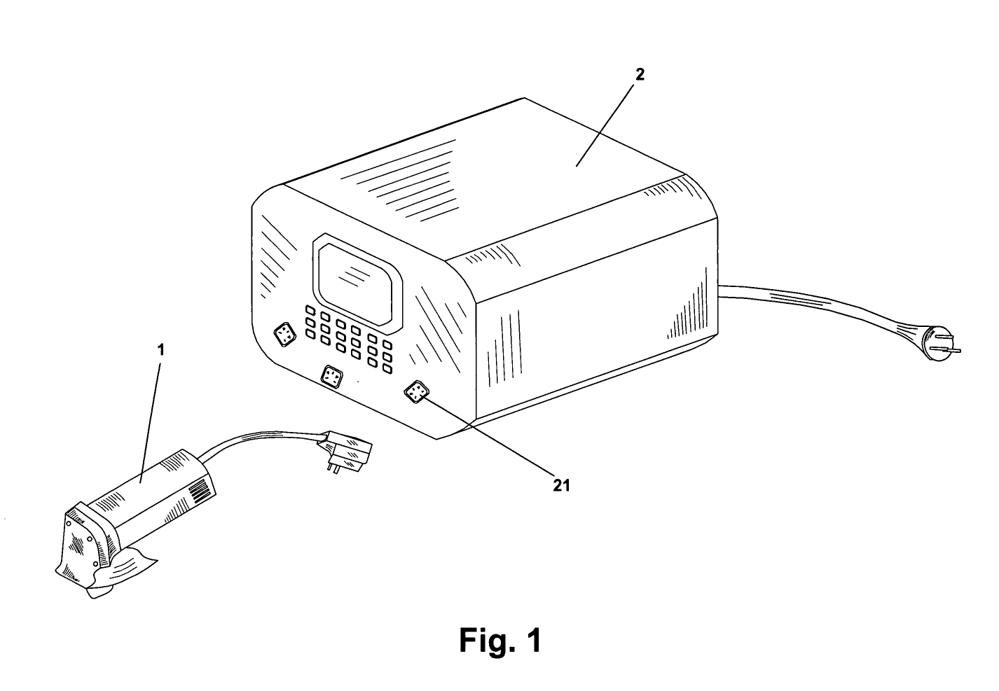

As shown in FIG. 1, an angle grinding machine adopting novel power source includes a split type power source 2 and at least two appliance bodies 1 of two angle grinding machine. There are at least two output ports 21 on the power source 2 and the appliance body 1 can be connected to output port 21 in splicing. An alternative current servo controller is adopted in the said power source 2 and the input end of the power source 2 is powered by alternative current electric supply. Permanent magnet brushless direct current motors are adopted on the appliance body 1. The power source 2 is provided with four or five or six output ports 21 and one appliance body 1 can be connected to every output port 21.

The said alternative current servo controller includes a control panel and a power board. The control panel includes a digital signal processing chip and a programmable logic chip. High frequency pulse modulation control signals are generated by combining digital circuit and software control and they are outputted to various output ports 21 after being amplified by the power board. The servo driver publicized in patent CN1549441A may be adopted for the alternative current servo controller.

The said permanent magnet brushless direct current motors include an electronic switch circuit, a rotor position detection circuit and a motor body. The said electronic switch circuit, the rotor position detection circuit and the motor body consist of a closed loop in sequence. The said motor body includes a coaxial external armature and a coaxial internal armature. The external armature is a fixed stator and the internal armature is a rotatable rotor which is a permanent magnet. Main role of the electronic switch circuit is to control the electrifying sequence and time of various phases of windings in stator of the motor body and the electronic switch circuit mainly consists of a power tube, a driving circuit and a rotor position signal processing module. Main role of the rotor position detection circuit is to detect position of the rotor in real time so that to provide foundation for phase change.

### Example 2

A cutting machine adopting novel power source includes a split type power source 2 and at least two appliance bodies 1 of two angle grinding machine. There are at least two output ports 21 on the power source 2 and the appliance body 1 can be connected to output port 21 in splicing. An alternative current servo controller is adopted in the said power source 2 and the input end of the power source 2 is powered by alternative current electric supply. Permanent magnet brushless direct current motors are adopted on the appliance body 1. The power source 2 is provided with four or five or six output ports 21 and one appliance body 1 can be connected to every output port 21.

The said alternative current servo controller includes a control panel and a power board. The control panel includes a digital signal processing chip and a programmable logic chip. High frequency pulse modulation control signals are generated by combining digital circuit and software control and they are outputted to various output ports 21 after being amplified by the power board. The servo driver publicized in patent CN1549441A may be adopted for the alternative current servo controller.

The said permanent magnet brushless direct current motors include an electronic switch circuit, a rotor position detection circuit and a motor body. The said electronic switch circuit, the rotor position detection circuit and the motor body consist of a closed loop in sequence. The said motor body includes a coaxial external armature and a coaxial internal armature. The external armature is a fixed stator and the internal armature is a rotatable rotor which is a permanent magnet. Main role of the electronic switch circuit is to control the electrifying sequence and time of various phases of windings in stator of the motor body and the electronic switch circuit mainly consists of a power tube, a driving circuit and a rotor position signal processing module. Main role of the rotor position detection circuit is to detect position of the rotor in real time so that to provide foundation for phase change.

### Example 3

A mowing machine adopting novel power source includes a split type power source 2 and at least two appliance bodies 1 of two angle grinding machine. There are at least two output ports 21 on the power source 2 and the appliance body 1 can be connected to output port 21 in splicing. An alternative current servo controller is adopted in the said power source 2 and the input end of the power source 2 is powered by alternative current electric supply. Permanent magnet brushless direct current motors are adopted on the appliance body 1. The power source 2 is provided with four or five or six output ports 21 and one appliance body 1 can be connected to every output port 21.

The said alternative current servo controller includes a control panel and a power board. The control panel includes a digital signal processing chip and a programmable logic chip. High frequency pulse modulation control signals are generated by combining digital circuit and software control and they are outputted to various output ports 21 after being amplified by the power board. The servo driver publicized in patent CN1549441A may be adopted for the alternative current servo controller.

The said permanent magnet brushless direct current motors include an electronic switch circuit, a rotor position detection circuit and a motor body. The said electronic switch circuit, the rotor position detection circuit and the motor body consist of a closed loop in sequence. The said motor body includes a coaxial external armature and a coaxial internal armature. The external armature is a fixed stator and the internal armature is a rotatable rotor which is a permanent magnet. Main role of the electronic switch circuit is to control the electrifying sequence and time of various phases of windings in stator of the motor body and the electronic switch circuit mainly consists of a power tube, a driving circuit and a rotor position signal processing module. Main role of the rotor position detection circuit is to detect position of the rotor in real time so that to provide foundation for phase change.

### Example 4

An electric chain saw adopting novel power source includes a split type power source 2 and at least two appliance bodies 1 of two angle grinding machine. There are at least two output ports 21 on the power source 2 and the appliance body 1 can be connected to output port 21 in splicing. An alternative current servo controller is adopted in the said power source 2 and the input end of the power source 2 is powered by alternative current electric supply. Permanent magnet brushless direct current motors are adopted on the appliance body 1. The power source 2 is provided with four or five or six output ports 21 and one appliance body 1 can be connected to every output port 21.

The said alternative current servo controller includes a control panel and a power board. The control panel includes a digital signal processing chip and a programmable logic chip. High frequency pulse modulation control signals are generated by combining digital circuit and software control and they are outputted to various output ports 21 after being amplified by the power board. The servo driver publicized in patent CN1549441A may be adopted for the alternative current servo controller.

The said permanent magnet brushless direct current motors include an electronic switch circuit, a rotor position detection circuit and a motor body. The said electronic switch circuit, the rotor position detection circuit and the motor body consist of a closed loop in sequence. The said motor body includes a coaxial external armature and a coaxial internal armature. The external armature is a fixed stator and the internal armature is a rotatable rotor which is a permanent magnet. Main role of the electronic switch circuit is to control the electrifying sequence and time of various phases of windings in stator of the motor body and the electronic switch circuit mainly consists of a power tube, a driving circuit and a rotor position signal processing module. Main role of the rotor position detection circuit is to detect position of the rotor in real time so that to provide foundation for phase change.

The invention is suitable for such electric appliances as portable electric tools, moveable electric tools, gardening tools and woodworking tools.

Above implementation examples are explanations on the invention but not restrictions on the invention. Any schemes of simply changing the invention belong to the protection scope of the invention.

What is claimed is:

1. An electric appliance adopting novel power source wherein the appliance includes a split type power source (2) and at least two appliance bodies (1), the power source (2) is provided with at least two output ports (21) and the appliance body (1) can be connected to the output ports (21) in splicing; and an alternative current servo controller is adopted in the said power source (2) and input end of the power source (2) is powered by alternative current electric supply, and permanent magnet brushless direct current motors are used on the appliance body (1).

2. The electric appliance adopting novel power source as claimed in claim 1 wherein the power source (2) is provided with four output ports (21) and one appliance body (1) can be connected to every output port (21).

3. The electric appliance adopting novel power source as claimed in claim 1 wherein the power source (2) is provided with five output ports (21) and one appliance body (1) can be connected to every output port (21).

4. The electric appliance adopting novel power source as claimed in claim 1 wherein the power source (2) is provided with six output ports (21) and one appliance body (1) can be connected to every output port (21).

5. The electric appliance adopting novel power source as claimed in claim 1 wherein the said alternative current servo controller includes a control panel and a power board. The control panel includes a digital signal processing chip and a programmable logic chip and high frequency pulse modulation control signals are generated by combining digital circuit and software control and they are outputted to various output ports (21) after being amplified by the power board.

6. The electric appliance adopting novel power source as claimed in claim 1 wherein the said permanent magnet brushless direct current motors include an electronic switch circuit, a rotor position detection circuit and a motor body, and the said electronic switch circuit, the rotor position detection circuit and the motor body consist of a closed loop in sequence.

7. The electric appliance adopting novel power source as claimed in claim 2 wherein the said permanent magnet brushless direct current motors include an electronic switch circuit, a rotor position detection circuit and a motor body, and the said electronic switch circuit, the rotor position detection circuit and the motor body consist of a closed loop in sequence.

8. The electric appliance adopting novel power source as claimed in claim 3 wherein the said permanent magnet brushless direct current motors include an electronic switch circuit, a rotor position detection circuit and a motor body, and the said electronic switch circuit, the rotor position detection circuit and the motor body consist of a closed loop in sequence.

9. The electric appliance adopting novel power source as claimed in claim 4 wherein the said permanent magnet brushless direct current motors include an electronic switch circuit, a rotor position detection circuit and a motor body, and the said electronic switch circuit, the rotor position detection circuit and the motor body consist of a closed loop in sequence.

10. The electric appliance adopting novel power source as claimed in claim 5 wherein the said permanent magnet brushless direct current motors include an electronic switch circuit, a rotor position detection circuit and a motor body, and the said electronic switch circuit, the rotor position detection circuit and the motor body consist of a closed loop in sequence.

11. The electric appliance adopting novel power source as claimed in claim 6 wherein the said motor body includes a coaxial external armature and a coaxial internal armature and the external armature is a fixed stator and the internal armature is a rotatable rotor which is a permanent magnet.

12. The electric appliance adopting novel power source as claimed in claim 7 wherein the said motor body includes a coaxial external armature and a coaxial internal armature and the external armature is a fixed stator and the internal armature is a rotatable rotor which is a permanent magnet.

13. The electric appliance adopting novel power source as claimed in claim 8 wherein the said motor body includes a coaxial external armature and a coaxial internal armature and the external armature is a fixed stator and the internal armature is a rotatable rotor which is a permanent magnet.

14. The electric appliance adopting novel power source as claimed in claim 9 wherein the said motor body includes a coaxial external armature and a coaxial internal armature and the external armature is a fixed stator and the internal armature is a rotatable rotor which is a permanent magnet.

15. The electric appliance adopting novel power source as claimed in claim 10 wherein the said motor body includes a coaxial external armature and a coaxial internal armature and the external armature is a fixed stator and the internal armature is a rotatable rotor which is a permanent magnet.

16. A power source for an electric appliance, wherein at least two output ports (21) are provided on the power source and the appliance body (1) can be connected to the output ports (21); and an alternative current servo controller is adopted for the said power source and the input end of the power source is powered by alternative current electric supply.

17. The power source as claimed in claim 16 wherein the power source (2) is provided with four or five or six output ports (21) and one appliance body (1) can be connected to every output port (21).

18. The power source as claimed in claim 16 wherein the said alternative current servo controller includes a control panel and a power board; the control panel includes a digital signal processing chip and a programmable logic chip so that high frequency pulse modulation control signals are generated by combining digital circuit and software control and they are outputted to various output ports (21) after being amplified by the power board.
